(19) United States
(12) Patent Application Publication
(10) Pub. No.: US 2022/0402725 A1
(43) Pub. Date: Dec. 22, 2022

(54) TOUCHLESS ELEVATOR OPERATION

(71) Applicants: Anas Siddiqui, Milton (CA); Nabeela Siddiqui, Milton (CA)

(72) Inventors: Anas Siddiqui, Milton (CA); Nabeela Siddiqui, Milton (CA)

(21) Appl. No.: 17/841,405

(22) Filed: Jun. 15, 2022

Related U.S. Application Data
(60) Provisional application No. 63/210,908, filed on Jun. 15, 2021.

(51) Int. Cl. B66B 1/46

(52) U.S. Cl. CPC B66B 1/468; B66B 2201/4623; B66B 2201/4646

(57) ABSTRACT

This disclosure describes systems, methods, and devices related to touchless elevator. A device may detect a first touchless command received from a user, wherein the first touchless command is to control an elevator. The device may generate a feedback signal indicating a recognition of the first touchless command. The device may detect a second touchless command associated with moving the elevator to a designated floor in a building. The device may generate a signal to cause the elevator to move the designated floor.

### CROSS-REFERENCE TO RELATED PATENT APPLICATION(S)

This application claims the benefit of U.S. Provisional Application No. 63/210,908, filed Jun. 15, 2021, the disclosure of which is incorporated by reference as set forth in full.

### TECHNICAL FIELD

This disclosure generally relates to systems and methods for elevator operations and, more particularly, to the touchless operation of elevators.

### BACKGROUND

Elevators are becoming more popular in both businesses and homes. There are some advantages to using elevators. Elevators, for example, make it easy for people to travel from one floor to the next. Elevators also enable users to quickly transport items between floors and allow elderly people to avoid using stairs. However, using elevators can be inconvenient when they are overcrowded or a person is unable to reach or push the control buttons to move between floors. In such cases, a system to provide better control of elevator operation.

### BRIEF DESCRIPTION OF THE DRAWINGS

FIG. 1 depicts an illustrative schematic diagram for a touchless elevator system, in accordance with one or more example embodiments of the present disclosure.

FIG. 2 depicts an illustrative schematic diagram for a touchless elevator system, in accordance with one or more example embodiments of the present disclosure.

FIG. 3 depicts an illustrative schematic diagram for a touchless elevator system, in accordance with one or more example embodiments of the present disclosure.

FIG. 4 depicts an illustrative schematic diagram for a touchless elevator system, in accordance with one or more example embodiments of the present disclosure.

FIG. 5 depicts an illustrative schematic diagram for a touchless elevator system, in accordance with one or more example embodiments of the present disclosure.

FIG. 6 illustrates a flow diagram of a process for an illustrative touchless elevator system, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in or substituted for, those of other embodiments. Embodiments set forth in the claims encompass all available equivalents of those claims.

An elevator includes a cab (also referred to as a cabin, cage, carriage, or car) mounted on a platform within an enclosed space known as a shaft or sometimes a hoistway.

An elevator cab is a space with a challenging acoustic environment depending on the passenger traffic, inside surfaces (wood, glass, metal, etc.), fans, elevator motion sounds, etc. Most of the elevators do not have internet connectivity and therefore a typical online solution using “Alexa” or “Hey Google” would not work. Since this solution requires the touchless operation of elevators, some jurisdictions require that the solution is offline to ensure that the system cannot be hacked and can be controlled remotely. These are unique sets of boundaries to determine a solution that is purposefully built for the touchless operation of elevators.

There are multiple patents on voice-activated elevators but most of these implementations are done at the elevator control system level, that is, a central controller which controls the elevator buttons and the hall station buttons.

Example embodiments of the present disclosure relate to systems, methods, and devices for processing the audio and/or video inputs to control the elevator button without interfacing with the elevator control systems.

In one embodiment, a touchless elevator system may use facial recognition to determine which floor button needs to be activated by using the video input and recognizing the person in real-time. The facial recognition can be done based on locally stored images and mapping them to floor levels.

In one or more embodiments, a touchless elevator system may learn and capture information about users to determine which user goes to which level and uses the learned model to automatically activate those floor buttons once the system recognizes a person mapped to a floor level in the system without them touching the button or even saying the floor number.

In one embodiment, a touchless elevator system may facilitate the parametrization of a confidence score, and adjusting this score manually or automatically to adapt to the acoustic environment of the elevator and also to support multiple languages is a unique benefit that enhances the user experience.

In one or more embodiments, a touchless elevator system may use voice and/or video inputs and learns over the period to approach an enhanced accuracy of touchless operation of elevators, resulting in a similar effect as pushing the mechanical buttons of an elevator.

In one or more embodiments, a touchless elevator system may have the ability for our system to become more accurate over time. This will be done by capturing the wake words and voice commands over time and post-analyzing them to improve the speech recognition model and/or facial recognition model to get to a close to 100% recognition. Today, typical voice/facial systems in a real-life scenario results in ˜90% accuracy and this is one of the factors why voice/video recognition is not considered an accurate method to replace the push buttons.

The speech recognition model can be uniquely adjusted to the elevator's acoustics profile, noise profile, and user profile to achieve closer to 100% accurate touchless operation of elevators.

In one or more embodiments, a touchless elevator system may facilitate an audio/video/text device for supporting emergency communication from inside the elevator to the security monitoring station. The touchless elevator system may use voice control to call for help (“Elevator” “Call for HELP”) instead of pressing the HELP button. This may be beneficial for the visually impaired or people who are in distress or have collapsed. The user may call for help instead of getting up and pushing the HELP button.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

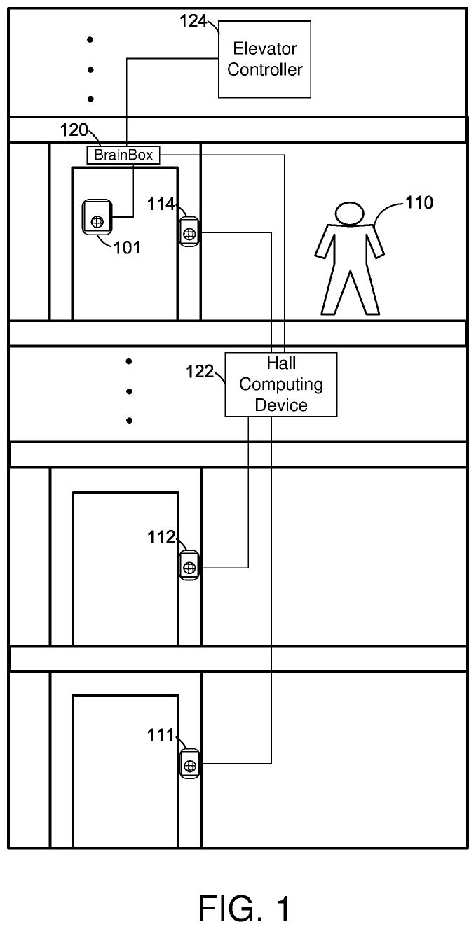

FIG. 1 is a diagram illustrating an example environment of a touchless elevator system, according to some example embodiments of the present disclosure.

Referring to FIG. 1, there is shown a multi-floor building comprising one or more components of the touchless elevator system. For example, an elevator shaft may comprise various components, an elevator car unit, an electric source, a traveler cable, a power supply unit (PSU), and other components used for the implementation of an elevator. An elevator car unit may comprise a microphone or an array of microphones to improve the accuracy and reliability of the voice signal and the overall accuracy of the touchless elevator system. The PSU may be mounted using a mounting mechanism, for example, it may be mounted on a DIN rail. A DIN rail may be a metal rail of a standard type used for mounting circuit breakers and industrial control equipment inside equipment racks. The PSU may be inside a junction box (e.g., a NEMA 1 or other types of junction box). The traveler cable may connect the electric source to an elevator car transmission control protocol (TCP) box. Controls for the touchless elevator system may be comprised within the junction box in addition to a relay board.

For example, FIG. 1 shows a number of floors of a building. Each of the floors may have a hall unit (e.g., hall units 111, 112, and 114) that may be connected to a hall computing device 122 having multiple USB ports. Each hall unit may comprise a microphone (e.g., a USB microphone, Bluetooth, or other types of microphones) and/or a camera and may also have a mechanical interface such as a set of hall station buttons (e.g., up or down buttons).

The hall computing device may also be a BrainBox which is programmed for hall station buttons (going up and down). The BrainBox 120 may be located on top of the elevator car and may be programmed to work with the inside elevator car buttons. In a high-rise building installation, the hall computing device and the BrainBox may not communicate with each other. In a small rise or a residential implementation with two floors, the brainbox 120 may be located in a machine room close to the elevator controller and controls microphone on the outside and the inside of the elevator (e.g., three microphones—one microphone for inside the elevator car, and two mics for the hall stations). The BrainBox enables a distributed architecture controlling multiple microphones and/or cameras. In the case of utilizing a camera to perform facial recognition, different BrainBoxes may be connected to a central server (where the administrator adds images of users and maps them to their respective floors). The administrator may update the photos locally on the brainboxes so that the touchless elevator system can make a determination locally for the person and activates the corresponding floor button.

The BrainBox 120 may be installed on top of the elevator car invisible to passengers of the elevator. The BrainBox 120 may be a controller device that connects to an existing elevator controller to modernize and allow the enhanced functionalities described herein of the touchless elevator system. There may be a plurality of hall computing devices that may be connected to a group of floors (e.g., four floors, etc.). Inside the elevator car, there may be an elevator car unit (e.g., elevator car unit 101) that may comprise an existing mechanical interface (e.g., floor buttons) for manual operation but also may touchless elevator comprise a microphone and/or a camera for implementation of the touchless elevator system. The hall computing device 112 and the BrainBox 120 may be wired to the manual interfaces in such a way as to bypass these manual interfaces through the various microphones and/or cameras installed on each floor and inside the elevator car. The BrainBox 120 may be connected to an existing elevator controller (e.g., elevator controller 124). The touchless elevator system may bypass existing mechanical interfaces by receiving input from the microphones and/or cameras and processing the input in order to activate the existing elevator controller and operate the elevator based on the input.

In one or more embodiments, a touchless elevator system may precisely control the behavior of an elevator button electrically using voice control in multiple languages by bypassing the action of mechanically pushing an elevator button. For example, a user 110 may say a wake word “Elevator” to activate the touchless elevator system and then will call for a command (“Floor 1”, “Call for Help,” “Going Up,” etc.) to activate the elevator buttons. There are two versions of this solution available offline/embedded and online/connected to the internet.

In one or more embodiments, a touchless elevator system may instead of voice input, may capture an image of a person to be used as input into the BrainBox 120. For example, as the user 110 approaches a hall unit, a camera in a hall unit may capture an image of the user 110. The image may be passed to the BrainBox 120, which performs image recognition and selects a destination floor based on the user 110 and the specific floor associated with the user 110. Information may be known about a specific user that goes to a specific floor or works at a specific location in the building. This information may be an association between a user and a floor. That association may be based on historical data of a user regularly requesting a specific floor or based on input into a database that associates the user with a specific floor.

In one or more embodiments, a touchless elevator system may facilitate off-line version support for multiple languages such that the confidence score is adjusted to ensure that the end-user experience with multiple languages (e.g., English and/or Spanish) is the same. In one or more embodiments, the voice recognition confidence score may be directly proportional to the delay the system experiences in recognizing the voice command. One challenge in supporting multiple languages is that the grammar of each language is complex and with added language support the system becomes slow to respond. In one or more embodiments, a touchless elevator system may facilitate parameterizing the confidence score such that it continues to recognize the primary system language with a minimal delay while secondary languages may take longer to respond.

In one or more embodiments, a touchless elevator system may monitor voice recognition failures that may be captured. The touchless elevator system may automatically adjust the confidence score to optimize for the least amount of voice recognition failures. This is especially important since a high confidence score does not always mean correct voice recognition as the confidence score can be negatively impacted by the surrounding noisy environment.

In one or more embodiments, a touchless elevator system may detect who gave the voice command to determine a mapping table of a person and its desired floor. Once the touchless elevator system knows that, the touchless elevator system may automatically activate the correct floor number without the passenger calling for the floor number or pushing the button. In other words, the touchless elevator system may learn information associated with a user and the floor the user is going to. The touchless elevator system may then use a mapping table based on the user and the floor and uses this information to activate the floor buttons without pushing or even voice activating the floor level using video input.

In one or more embodiments, in an online version, a touchless elevator system may, besides the features of the offline version, capture the voice samples for the recognition successes and failures to continuously improve the machine learning model to increase the recognition accuracy.

In one or more embodiments, a touchless elevator system may utilize a recognition solution to create a model for voice recognition that allows for the parameterization of the confidence score, accuracy, and recognition delay. The implementation is done on an off-the-shelf single board computer (e.g., Raspberry Pi 4, or any other platform) to control the relays that connect to the elevator buttons in parallel or may be implemented on a custom-built printed circuit board.

In one or more embodiments, for an installation inside-elevator, one device may be installed per elevator while for the hall stations, a touchless elevator system may support multiple floor levels by connecting several microphones (e.g., up to 4 microphones) to the same computing device (e.g., Raspberry Pi 4, or any other platform) and to enable multiple floors (e.g., up to four, that may be limited by the number of USB ports supported by the computing device) with voice-controlled operation using one touchless elevator system. Each floor may be considered acoustically isolated from the other floor. This is a unique method of enabling voice control by a single computing device on multiple floors. One benefit of this method is that it helps to identify the distribution of the floors to which the elevator stops by collecting the data on how many times a floor number is called for. Collecting this information in a manner that is agnostic to the elevator controller allows for a solution to determine how many times an elevator is stopping at any floor representing the usage of elevator doors that needs to be serviced every x amount of door open/closed events. It is known that over 80% of entrapments in elevators are due to door malfunction and determining when to service these doors can help reduce the elevator door malfunctioning.

In one or more embodiments, a voice or image-controlled operation of elevators either as a retrofit solution to the existing button panel or a solution that may be integrated with the elevator fixtures. A touchless elevator system may modernize an existing elevator in order to introduce enhanced features. This provides an add-on solution retrofitted to existing elevators.

In one or more embodiments, a touchless elevator system may facilitate a first process using a single language support. In this first process, a user may activate a voice control system by saying the wake word (“Elevator”). A visual and/or audio feedback from the touchless elevator system may inform the user that the wake word has been recognized and the touchless elevator system is listening.

In response, the user may say the voice command (for example—“Floor 2”). It should be understood that multiple users can say multiple commands one after the other while the system is active. The touchless elevator system may recognize the voice command(s) and converts it into an electrical signal to sequentially toggle the connected relay so as to reproduce the mechanical push button behavior of pushing the elevator button. The voice commands that are falsely recognized will lead to visual and/or audio feedback so that the user can repeat that command. The touchless elevator system may then facilitate the respective elevator button(s) to be activated.

In one or more embodiments, a touchless elevator system may facilitate a second process using multiple language support. In this second process, a user may use the voice control system by saying the wake word in any one of the supported languages (“Elevator”, “Ascensor,” “Elevador,” or any other wake word). It should be understood that the wake-up word may be implementation-specific and may vary from one scenario to another. The wake-up word may be determined by a system administrator of the touchless elevator system.

In one or more embodiments, visual and/or audio feedback from the system indicates to the user that the wake word has been recognized and the touchless elevator system is listening. In that case, the user may say the voice command (for example—“Floor” 2). It should be understood that multiple users can say multiple commands in the same language as the language used with wake word one after the other while the system is active.

It should also be understood that one microphone may be using an English dictionary while another microphone is using a Spanish dictionary.

Further, the wake word language may also determine the grammar to be used for the voice commands. For example, if the wake word was in Spanish, the touchless elevator system may determine that the grammar to be used for the voice commands is also Spanish.

In one or more embodiments, a touchless elevator system may recognize the voice command(s) and converts it into an electrical signal to sequentially toggle the connected relay so as to reproduce the mechanical push button behavior of pushing the elevator button. In case voice commands are falsely recognized, the touchless elevator system may facilitate visual and/or audio feedback so that the user can repeat that command. The touchless elevator system may then facilitate the respective elevator button(s) to be activated

In one or more embodiments, a touchless elevator system may receive simultaneous touchless activations on multiple floors where it can receive the voice commands from multiple microphones (on different floors) and simultaneously control the buttons on these floors.

In one or more embodiments, a touchless elevator system may be deployed in other public places like manufacturing plants, subway stations, or other places where there is a need for touchless operation of doors, entrances, etc.

It is understood that the above descriptions are for purposes of illustration and are not meant to be limiting.

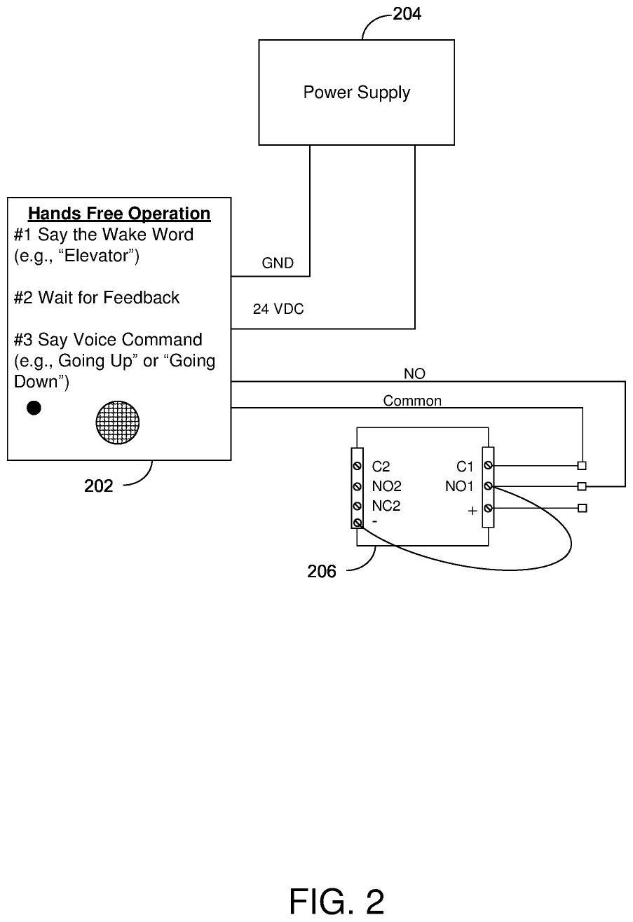

FIG. 2 depicts an illustrative schematic diagram for a touchless elevator system, in accordance with one or more example embodiments of the present disclosure.

Referring to FIG. 2, there is shown a hall unit 202 wiring diagram. The hall unit 202 may be located on the outside of the elevator in a hall on a specific floor of a building. The hall unit 202 may comprise a microphone and/or a camera that receives input from the user in order to activate an existing elevator system using speech and/or image recognition. The hall unit 202 may be retrofitted into an existing elevator system in order to bypass mechanical or touch-based systems that effectuate the operation of an elevator. The hall unit 202 may be connected to a power supply unit 204 and may also be connected to a relay board 206. The connections between the hall unit 202 and the relay board 206 may be implemented to allow the hall unit 202 to bypass the mechanical input function of an existing button panel that operates the elevator. In such a situation, voice and/or image data may be used to control the operation of the elevator. The touchless elevator system may take control of the activation and deactivation of the existing elevator system based on the inputs. However, the mechanical operation of the elevator may continue to function as originally intended in conjunction with the integration of the touchless elevator system.

It is understood that the above descriptions are for purposes of illustration and are not meant to be limiting.

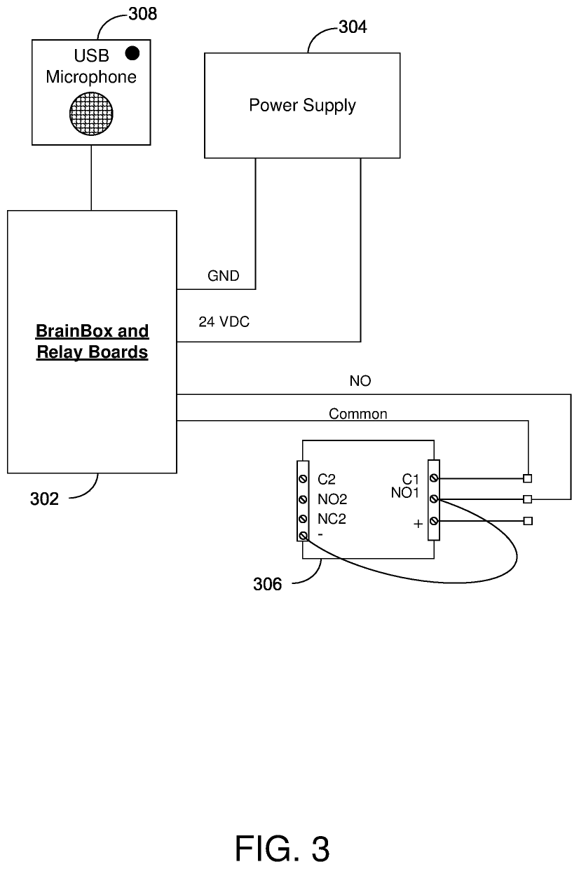

FIG. 3 depicts an illustrative schematic diagram for a touchless elevator system, in accordance with one or more example embodiments of the present disclosure.

Referring to FIG. 3, there is shown an elevator car unit 308 wiring diagram. A microphone (e.g., a USB microphone, Bluetooth, or other types of microphones) may be included in the elevator car unit 308. The elevator car unit 306 may be connected to a BrainBox 302 comprising various components including, but not limited to, a CPU, a USB microphone, a relay board 306, and one or more controllers associated with the touchless elevator system to be retrofitted and operate an existing elevator system. The BrainBox 302 may be connected to a power supply unit 304 and may also be connected to a relay board 306. The wiring of the BrainBox 302 and the relay board 308 may be implemented to allow the BrainBox 302 to bypass the mechanical input functions of an existing button panel that operates the elevator. In such a situation, voice and/or image data may be used to control the operation of the elevator. However, the mechanical operations (e.g., using touch or mechanical buttons) of the elevator may continue to function as originally intended before the integration of the touchless elevator system.

It is understood that the above descriptions are for purposes of illustration and are not meant to be limiting.

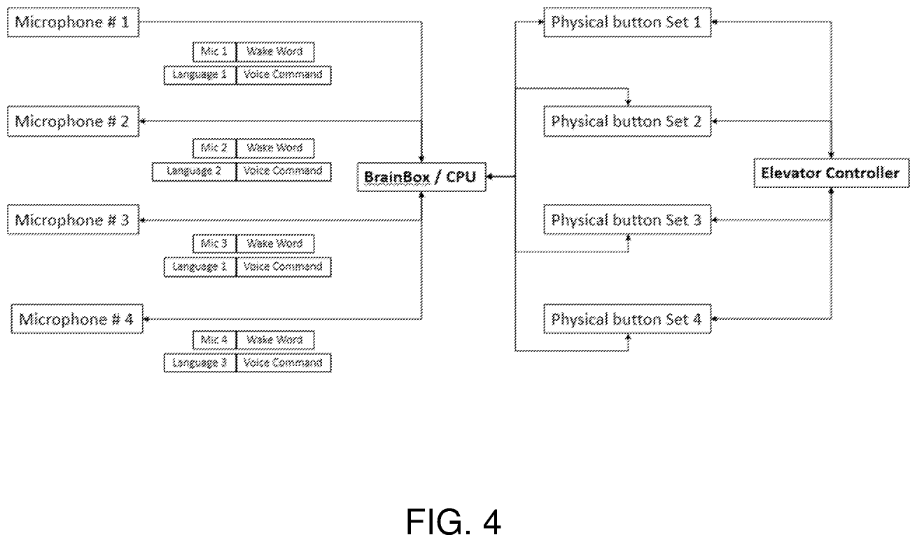

FIG. 4 depicts an illustrative schematic diagram for a touchless elevator system, in accordance with one or more example embodiments of the present disclosure.

Referring to FIG. 4, there is shown a configuration connecting the brainbox 402 with four microphones and connecting existing mechanical/physical buttons from various floors that originally connected to an existing elevator controller 404. As can be seen in FIG. 4, each microphone may be located on a particular floor in a building. For example, microphone #1 may be located on floor #1, microphone #2 may be located on floor #2, microphone #3 may be located on floor #3, and microphone #4 may be located on floor #4. Each microphone may receive a wake word from a user in order to activate the touchless elevator system. The wake word and/or voice commands may be implemented using various languages. It should be understood that these microphones are independent of each other as far as the language selected to control the elevator. For example, the language used in microphone #1 may be English in order to control the elevator. However, the language used in microphone #3 may be French in order to control the elevator. Therefore, a plurality of users can operate the elevator using a preferred language. Although the example in FIG. 4 shows microphones, a similar application and implementation may be envisioned. In that case, image capture, image processing, and feedback may be implemented in order to bypass the mechanical or touch systems of an existing elevator system by integrating the touchless elevator system to provide enhancements to the existing elevator system.

It is understood that the above descriptions are for purposes of illustration and are not meant to be limiting.

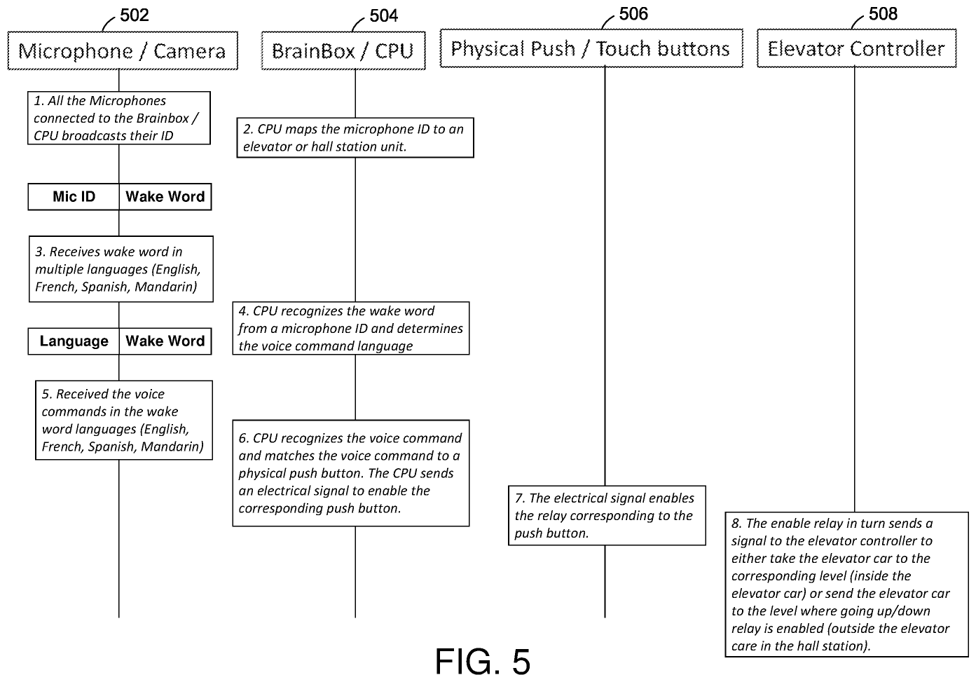

FIG. 5 depicts an illustrative schematic diagram for a touchless elevator system, in accordance with one or more example embodiments of the present disclosure.

Referring to FIG. 5, there is shown an input device such as a microphone and/or camera 502, a brainbox 504, physical/touch buttons 506, and an elevator controller 508 (of an existing elevator).

In one or more embodiments, when the microphones/cameras are operational after installation, these devices broadcast their IDs (e.g., microphone IDs and/or camera IDs) to the BrainBox/CPU 504. When the BrainBox/CPU 504 receives these broadcasted IDs from the plurality of microphone/cameras, the BrainBox/CPU 504 may map these IDs to the elevator or hall station unit. Multiple microphones and/or cameras can be used inside the elevator car or hall station to enhance the robustness of audio/video signal and increase the accuracy of the speech/image recognition.

Looking at an example of a microphone, when a user speaks a wake word in a particular language, the microphone receives that wake word. The BrainBox/CPU 504 may recognize the wake word received from that particular microphone ID and determines the voice command language (e.g. French) and enables the embedded voice command dictionary of that language for the microphone ID. This enables multiple connected microphones supporting different languages at the same time. At this point, the user may provide a command in the language utilized in the wake word languages (e.g., English, French, Spanish, Mandarin, etc.).

The BrainBox/CPU 504 recognizes the voice command in the wake word language (e.g., French or other languages) and matches the voice command to a physical push button. BrainBox/CPU 504 may then send an electrical signal to enable the corresponding push button. The electrical signal enables (activates) the relay corresponding to the push button. The enabled relay in turn sends a signal to the elevator controller to either take the elevator car to the corresponding level (inside the elevator car) or send the elevator car to the level where the going up/down relay is enabled (outside the elevator car in the hall station). Table 1 below shows some examples of touchless voice commands that illustrate the operation of the touchless elevator system.

TABLE 1
Sample Touchless Control Commands:

| Offline Voice | English | French | Spanish |
|---|---|---|---|
| Wake Word | Elevator | Ascenseur | Elevador |
| Voice Commands - | Floor 1, | Étage Un | primer piso |
| Elevator Car | First Floor | | |
| | Floor 2, | Étage Deux | Piso dos, |
| | Second Floor | | Segundo piso |
| | Basement 1 | Sous-Sol Un | Sótano uno |
| | Ground Floor | Rez-De-Chaussée | Planata baja |
| | Open Door | Ouvre Fa Porte | puerta abierta |
| | Close Door | Ferme La Porte | puerta cerrada |
| | Call Help | Appeler à | Pide ayuda, |
| | | l'aide | llama a ayuda |
| Voice Commands | Going Up | Monter | Sube |
| Hall Station (outside | Going Down | Descente | Baja |
| elevator car) | | | |

It should be understood that these are only meant for illustration purposes and that other commands may be envisioned.

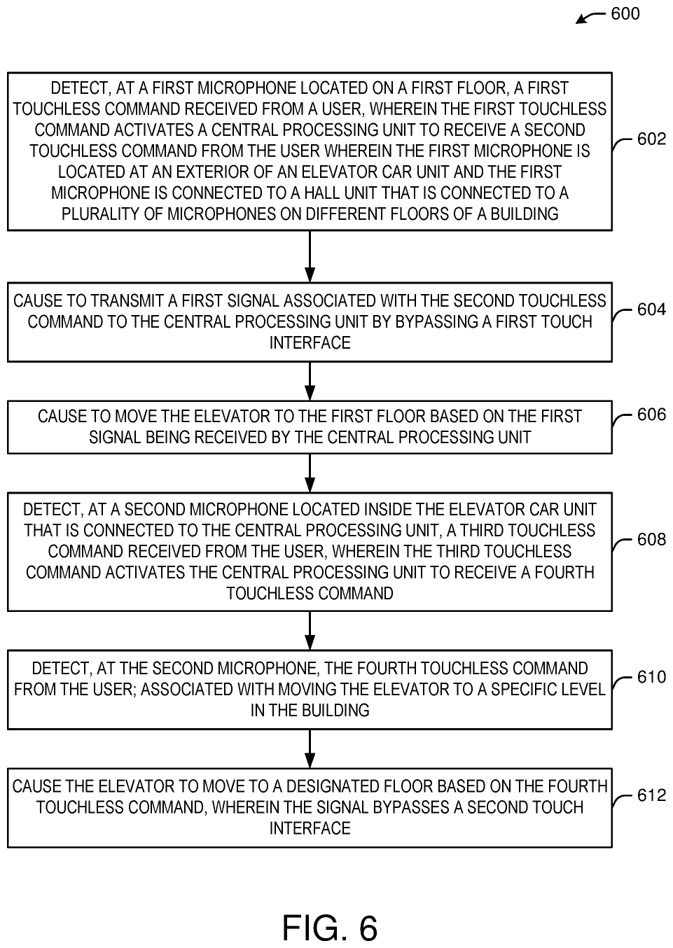

FIG. 6 illustrates a flow diagram of illustrative process 600 for a touchless elevator system, in accordance with one or more example embodiments of the present disclosure.

At block 602, a device (e.g., a controller associated with the touchless elevator system) may detect, at a first microphone located on a first floor, a first touchless command received from a user, wherein the first touchless command activates a central processing unit to receive a second touchless command from the user wherein the first microphone is located at an exterior of an elevator car unit and the first microphone is connected to a hall unit that is connected to a plurality of microphones on different floors of a building.

At block 604, the device may cause to transmit a first signal associated with the second touchless command to the central processing unit by bypassing a first touch interface.

At block 606, the device may cause to move the elevator to the first floor based on the first signal being received by the central processing unit.

At block 608, the device may detect, at a second microphone located inside the elevator car unit that is connected to the central processing unit, a third touchless command received from the user, wherein the third touchless command activates the central processing unit to receive a fourth touchless command.

At block 610, the device may detect, at the second microphone, the fourth touchless command from the user; associated with moving the elevator to a specific level in the building.

At block 612, the device may cause the elevator to move to a designated floor based on the fourth touchless command, wherein the signal bypasses a second touch interface.

In one or more embodiments, the first touchless command, the second touchless command, the third touchless command, or the fourth touchless command comprise an audio command or a visual input.

In one or more embodiments, the visual input is based on image recognition of the user.

In one or more embodiments, the device may generate a feedback signal indicating to the user a recognition of the first touchless command.

In one or more embodiments, the device may detect an error in recognizing the second touchless command or the third touchless command. The device may generate a visual or an audio error feedback signal indicating to the user to repeat the second touchless command or the third touchless command.

In one or more embodiments, a plurality of languages may be supported for recognizing touchless commands.

In one or more embodiments, the device may select a language associated with the first touchless command. The device may utilize the language in subsequent communications.

In one or more embodiments, the device may determine to recognize multiple commands in the selected language from a plurality of users.

In one or more embodiments, a language used on the first microphone may different from a language used on the second microphone.

It is understood that the above descriptions are for purposes of illustration and are not meant to be limiting.

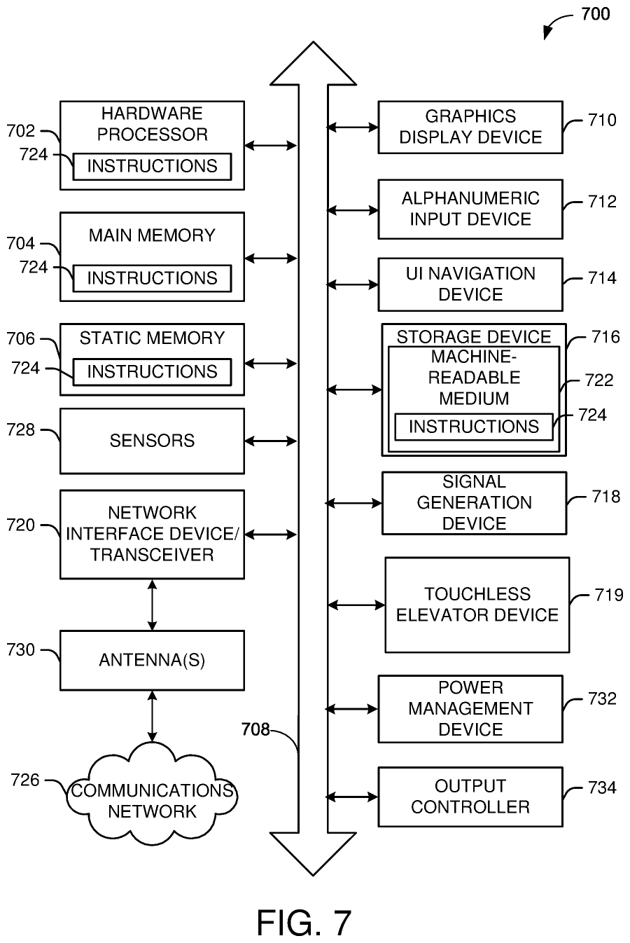

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a microphone, video camera, speaker), a touchless elevator device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The touchless elevator device 719 may carry out or perform any of the operations and processes (e.g., process 500) described and shown above.

It is understood that the above are only a subset of what the touchless elevator device 719 may be configured to perform and that other functions included throughout this disclosure may also be performed by the touchless elevator device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

It is understood that the above descriptions are for purposes of illustration and are not meant to be limiting.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; CD-ROM and DVD-ROM disks; and micro and mini SD cards.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others such as 4G/LTE or 5G. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

The following examples pertain to further embodiments.

Example 1 may include a device comprising processing circuitry coupled to storage, the processing circuitry configured to: detect, at a first microphone located on a first floor, a first touchless command received from a user, wherein the first touchless command activates a central processing unit to receive a second touchless command from the user wherein the first microphone may be located at an exterior of an elevator car unit and the first microphone may be connected to a hall unit that may be connected to a plurality of microphones on different floors of a building; cause to transmit a first signal associated with the second touchless command to the central processing unit by bypassing a first touch interface; cause to move the elevator to the first floor based on the first signal being received by the central processing unit; detect, at a second microphone located inside the elevator car unit that may be connected to the central processing unit, a third touchless command received from the user, wherein the third touchless command activates the central processing unit to receive a fourth touchless command; detect, at the second microphone, the fourth touchless command from the user; associated with moving the elevator to a specific level in the building; and cause the elevator to move to a designated floor based on the fourth touchless command, wherein the signal bypasses a second touch interface.

Example 2 may include the device of example 1 and/or some other example herein, wherein the first touchless command, the second touchless command, the third touchless command, or the fourth touchless command comprise an audio command or a visual input.

Example 3 may include the device of example 2 and/or some other example herein, wherein the visual input may be based on image recognition of the user.

Example 4 may include the device of example 1 and/or some other example herein, wherein the processing circuitry may be further configured to generate a feedback signal indicating to the user a recognition of the first touchless command.

Example 5 may include the device of example 1 and/or some other example herein, wherein the processing circuitry may be further configured to: detect an error in recognizing the second touchless command or the third touchless command; and generate a visual or an audio error feedback signal indicating to the user to repeat the second touchless command or the third touchless command.

Example 6 may include the device of example 1 and/or some other example herein, wherein a plurality of languages are supported for recognizing touchless commands.

Example 7 may include the device of example 1 and/or some other example herein, wherein the processing circuitry may be further configured to: select a language associated with the first touchless command; and utilize the language in subsequent communications.

Example 8 may include the device of example 7 and/or some other example herein, wherein the processing circuitry may be further configured to determine to recognize multiple commands in the selected language from a plurality of users.

Example 9 may include the device of example 1 and/or some other example herein, wherein a language used on the first microphone may be different from a language used on the second microphone.

Example 10 may include a non-transitory computer-readable medium storing computer-executable instructions which when executed by one or more processors result in performing operations comprising: detecting, at a first microphone located on a first floor, a first touchless command received from a user, wherein the first touchless command activates a central processing unit to receive a second touchless command from the user wherein the first microphone may be located at an exterior of an elevator car unit and the first microphone may be connected to a hall unit that may be connected to a plurality of microphones on different floors of a building; causing to transmit a first signal associated with the second touchless command to the central processing unit by bypassing a first touch interface; causing to move the elevator to the first floor based on the first signal being received by the central processing unit; detecting, at a second microphone located inside the elevator car unit that may be connected to the central processing unit, a third touchless command received from the user, wherein the third touchless command activates the central processing unit to receive a fourth touchless command; detecting, at the second microphone, the fourth touchless command from the user; associated with moving the elevator to a specific level in the building; and causing the elevator to move to a designated floor based on the fourth touchless command, wherein the signal bypasses a second touch interface.

Example 11 may include the non-transitory computer-readable medium of example 10 and/or some other example herein, wherein the first touchless command, the second touchless command, the third touchless command, or the fourth touchless command comprise an audio command or a visual input.

Example 12 may include the non-transitory computer-readable medium of example 11 and/or some other example herein, wherein the visual input may be based on image recognition of the user.

Example 13 may include the non-transitory computer-readable medium of example 10 and/or some other example herein, wherein the operations further comprise generating a feedback signal indicating to the user a recognition of the first touchless command.

Example 14 may include the non-transitory computer-readable medium of example 10 and/or some other example herein, wherein the operations further comprise: detecting an error in recognizing the second touchless command or the third touchless command; and generating a visual or an audio error feedback signal indicating to the user to repeat the second touchless command or the third touchless command.

Example 15 may include the non-transitory computer-readable medium of example 10 and/or some other example herein, wherein a plurality of languages are supported for recognizing touchless commands.

Example 16 may include the non-transitory computer-readable medium of example 10 and/or some other example herein, wherein the operations further comprise: selecting a language associated with the first touchless command; and utilizing the language in subsequent communications.

Example 17 may include the non-transitory computer-readable medium of example 16 and/or some other example herein, wherein the operations further comprise determining to recognize multiple commands in the selected language from a plurality of users.

Example 18 may include the non-transitory computer-readable medium of example 10 and/or some other example herein, wherein a language used on the first microphone may be different from a language used on the second microphone.

Example 19 may include a method comprising: detecting, by one or more processors, at a first microphone located on a first floor, a first touchless command received from a user, wherein the first touchless command activates a central processing unit to receive a second touchless command from the user wherein the first microphone may be located at an exterior of an elevator car unit and the first microphone may be connected to a hall unit that may be connected to a plurality of microphones on different floors of a building; causing to transmit a first signal associated with the second touchless command to the central processing unit by bypassing a first touch interface; causing to move the elevator to the first floor based on the first signal being received by the central processing unit; detecting, at a second microphone located inside the elevator car unit that may be connected to the central processing unit, a third touchless command received from the user, wherein the third touchless command activates the central processing unit to receive a fourth touchless command; detecting, at the second microphone, the fourth touchless command from the user; associated with moving the elevator to a specific level in the building; and causing the elevator to move to a designated floor based on the fourth touchless command, wherein the signal bypasses a second touch interface.

Example 20 may include the method of example 19 and/or some other example herein, wherein the first touchless command, the second touchless command, the third touchless command, or the fourth touchless command comprise an audio command or a visual input.

Example 21 may include the method of example 20 and/or some other example herein, wherein the visual input may be based on image recognition of the user.

Example 22 may include the method of example 19 and/or some other example herein, further comprising generating a feedback signal indicating to the user a recognition of the first touchless command.

Example 23 may include the method of example 19 and/or some other example herein, further comprising: detecting an error in recognizing the second touchless command or the third touchless command; and generating a visual or an audio error feedback signal indicating to the user to repeat the second touchless command or the third touchless command.

Example 24 may include the method of example 19 and/or some other example herein, wherein a plurality of languages are supported for recognizing touchless commands.

Example 25 may include the method of example 19 and/or some other example herein, further comprising: selecting a language associated with the first touchless command; and utilizing the language in subsequent communications.

Example 26 may include the method of example 25 and/or some other example herein, further comprising determining to recognize multiple commands in the selected language from a plurality of users.

Example 27 may include the method of example 19 and/or some other example herein, wherein a language used on the first microphone may be different from a language used on the second microphone.

Example 28 may include an apparatus comprising means for: detecting, at a first microphone located on a first floor, a first touchless command received from a user, wherein the first touchless command activates a central processing unit to receive a second touchless command from the user wherein the first microphone may be located at an exterior of an elevator car unit and the first microphone may be connected to a hall unit that may be connected to a plurality of microphones on different floors of a building; causing to transmit a first signal associated with the second touchless command to the central processing unit by bypassing a first touch interface; causing to move the elevator to the first floor based on the first signal being received by the central processing unit; detecting, at a second microphone located inside the elevator car unit that may be connected to the central processing unit, a third touchless command received from the user, wherein the third touchless command activates the central processing unit to receive a fourth touchless command; detecting, at the second microphone, the fourth touchless command from the user; associated with moving the elevator to a specific level in the building; and causing the elevator to move to a designated floor based on the fourth touchless command, wherein the signal bypasses a second touch interface.

Example 29 may include the apparatus of example 28 and/or some other example herein, wherein the first touchless command, the second touchless command, the third touchless command, or the fourth touchless command comprise an audio command or a visual input.

Example 30 may include the apparatus of example 29 and/or some other example herein, wherein the visual input may be based on image recognition of the user.

Example 31 may include the apparatus of example 28 and/or some other example herein, further comprising generating a feedback signal indicating to the user a recognition of the first touchless command.

Example 32 may include the apparatus of example 28 and/or some other example herein, further comprising: detecting an error in recognizing the second touchless command or the third touchless command; and generating a visual or an audio error feedback signal indicating to the user to repeat the second touchless command or the third touchless command.

Example 33 may include the apparatus of example 28 and/or some other example herein, wherein a plurality of languages are supported for recognizing touchless commands.

Example 34 may include the apparatus of example 28 and/or some other example herein, further comprising: selecting a language associated with the first touchless command; and utilizing the language in subsequent communications.

Example 35 may include the apparatus of example 34 and/or some other example herein, further comprising determining to recognize multiple commands in the selected language from a plurality of users.

Example 36 may include the apparatus of example 28 and/or some other example herein, wherein a language used on the first microphone may be different from a language used on the second microphone.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device for an elevator control system, the device comprising processing circuitry coupled to storage, the processing circuitry configured to:
detect, at a first microphone located on a first floor, a first touchless command received from a user, wherein the first touchless command activates a central processing unit to receive a second touchless command from the user wherein the first microphone is located at an exterior of an elevator car unit and the first microphone is connected to a hall unit that is connected to a plurality of microphones on different floors of a building;
cause to transmit a first signal associated with the second touchless command to the central processing unit by bypassing a first touch interface;
cause to move the elevator to the first floor based on the first signal being received by the central processing unit;
detect, at a second microphone located inside the elevator car unit that is connected to the central processing unit, a third touchless command received from the user, wherein the third touchless command activates the central processing unit to receive a fourth touchless command;
detect, at the second microphone, the fourth touchless command from the user; associated with moving the elevator to a specific level in the building; and
cause the elevator to move to a designated floor based on the fourth touchless command, wherein the signal bypasses a second touch interface.

2. The device of claim 1, wherein the first touchless command, the second touchless command, the third touchless command, or the fourth touchless command comprise an audio command or a visual input.

3. The device of claim 2, wherein the visual input is based on image recognition of the user.

4. The device of claim 1, wherein the processing circuitry is further configured to generate a feedback signal indicating to the user a recognition of the first touchless command.

5. The device of claim 1, wherein the processing circuitry is further configured to:
detect an error in recognizing the second touchless command or the third touchless command; and
generate a visual or an audio error feedback signal indicating to the user to repeat the second touchless command or the third touchless command.

6. The device of claim 1, wherein a plurality of languages are supported for recognizing touchless commands.

7. The device of claim 1, wherein the processing circuitry is further configured to:
select a language associated with the first touchless command; and
utilize the language in subsequent communications.

8. The device of claim 7, wherein the processing circuitry is further configured to determine to recognize multiple commands in the selected language from a plurality of users.

9. The device of claim 1, wherein a language used on the first microphone is different from a language used on the second microphone.

10. A non-transitory computer-readable medium storing computer-executable instructions which when executed by one or more processors result in performing operations comprising:
detecting, at a first microphone located on a first floor, a first touchless command received from a user, wherein the first touchless command activates a central processing unit to receive a second touchless command from the user wherein the first microphone is located at an exterior of an elevator car unit and the first microphone is connected to a hall unit that is connected to a plurality of microphones on different floors of a building;
causing to transmit a first signal associated with the second touchless command to the central processing unit by bypassing a first touch interface;
causing to move the elevator to the first floor based on the first signal being received by the central processing unit;
detecting, at a second microphone located inside the elevator car unit that is connected to the central processing unit, a third touchless command received from the user, wherein the third touchless command activates the central processing unit to receive a fourth touchless command;
detecting, at the second microphone, the fourth touchless command from the user; associated with moving the elevator to a specific level in the building; and
causing the elevator to move to a designated floor based on the fourth touchless command, wherein the signal bypasses a second touch interface.

11. The non-transitory computer-readable medium of claim 10, wherein the first touchless command, the second touchless command, the third touchless command, or the fourth touchless command comprise an audio command or a visual input.

12. The non-transitory computer-readable medium of claim 11, wherein the visual input is based on image recognition of the user.

13. The non-transitory computer-readable medium of claim 10, wherein the operations further comprise generating a feedback signal indicating to the user a recognition of the first touchless command.

14. The non-transitory computer-readable medium of claim 10, wherein the operations further comprise:
detecting an error in recognizing the second touchless command or the third touchless command; and
generating a visual or an audio error feedback signal indicating to the user to repeat the second touchless command or the third touchless command.

15. The non-transitory computer-readable medium of claim 10, wherein a plurality of languages are supported for recognizing touchless commands.

16. The non-transitory computer-readable medium of claim 10, wherein the operations further comprise:
selecting a language associated with the first touchless command; and
utilizing the language in subsequent communications.

17. The non-transitory computer-readable medium of claim 16, wherein the operations further comprise determining to recognize multiple commands in the selected language from a plurality of users.

18. The non-transitory computer-readable medium of claim 10, wherein the language used on the first microphone is different from a language used on the second microphone.

19. A method comprising:
detecting, by one or more processors, at a first microphone located on a first floor, a first touchless command received from a user, wherein the first touchless command activates a central processing unit to receive a second touchless command from the user wherein the first microphone is located at an exterior of an elevator car unit and the first microphone is connected to a hall unit that is connected to a plurality of microphones on different floors of a building;
causing to transmit a first signal associated with the second touchless command to the central processing unit by bypassing a first touch interface;
causing to move the elevator to the first floor based on the first signal being received by the central processing unit;
detecting, at a second microphone located inside the elevator car unit that is connected to the central processing unit, a third touchless command received from the user, wherein the third touchless command activates the central processing unit to receive a fourth touchless command;
detecting, at the second microphone, the fourth touchless command from the user; associated with moving the elevator to a specific level in the building; and
causing the elevator to move to a designated floor based on the fourth touchless command, wherein the signal bypasses a second touch interface.

20. The method of claim 19, wherein the first touchless command, the second touchless command, the third touchless command, or the fourth touchless command comprise an audio command or a visual input.
